(19) United States
(12) Patent Application Publication
(10) Pub. No.: US 2008/0223941 A1
(43) Pub. Date: Sep. 18, 2008

(54) Systems and methods for processing measurement data

(76) Inventor: Zbigniew Roger Mrowiec, Paramus, NJ (US)

Correspondence Address: Pearl Cohen Zedek Latzer, LLP, 1500 Broadway, 12th Floor, New York, NY, 10036, US

(21) Appl. No.: 12/073,051

(22) Filed: Feb. 28, 2008

Related U.S. Application Data
(63) Continuation of application No. 11/319,864, filed on Dec. 27, 2005, now abandoned.

(51) Int. Cl. G06K 19/06

(52) U.S. Cl. 235/494

(57) ABSTRACT

Disclosed are systems and methods for collecting, processing and displaying medical measurement data in human-readable and machine-readable formats. The system may collect medical measurement data using one or more sensors. The system may then analyze the collected measurement data as well as various characteristics of the available display device. Based on these characteristics, the system may select an optimum barcode format for displaying the measurement data. The system may then convert the measurement data into the selected barcode format and display the measurement data in the selected barcode format and an alphanumeric format on the display device. The barcoded measurement data may then be scanned by a scanning device and transmitted to a computer system for storage and further analysis.

### CROSS REFERENCE TO RELATED APPLICATIONS

This U.S. patent application is a continuing application of prior application Ser. No. 11/319864, filed Dec. 27, 2005, which is incoprorated herein by reference in its entirety.

### FIELD OF INVENTION

The present invention relates generally to the field of data processing and more specifically to the systems and methods for collecting, processing, displaying and transferring medical measurement data in an error-free manner.

### BACKGROUND OF THE INVENTION

Medical errors is one of the leading problems of the healthcare industry in this country. Such errors are typically associated with inexperienced medical personal, new procedures, complex instruments, and, quite often, with medical data-entry mistakes. According to the healthcare industry survey, nearly half of the medical data-entry errors in the United States occur in the transcription or documentation phase, and a further thirty six percent during dispensing of the medication. About thirteen percent of the errors happen during prescribing, and four percent when medications are being administered. These data-entry mistakes often necessitate costly remedial actions. Moreover, detection of such errors often results in a decreased workflow efficiency of the medical institution, which costs time and money. Furthermore, a late detection of some medical errors may result in significant financial losses to the medical institution and, even worse, losses of human lives.

The majority of medical data-entry errors occur at the documentation phase of the medical diagnostic and treatment processes. Typically, healthcare patients are subjected to various medical tests and procedures provided by the health professionals to diagnose possible medical conditions and to determine a suitable course of treatment. Such procedures may involve taking patient's blood pressure, pulse, checking temperature, body weight, etc. The medical measurement readings, such as those generated by blood pressure monitors, digital scales, thermometers, pulse oximeters, etc., are then manually recorded in patient's file by the medical worker and may be later manually transferred to the computer. Such manual methods of recording medical measurement data are prone to entry or transcription errors, which often result in incorrectly prescribed medicine or a course of treatment. Moreover, some of the data-entry errors may result in a failure to detect and treat potentially serious medical conditions that would have been detected in absence of such errors.

The data-entry errors are not limited to the diagnostic and treatment segments of the healthcare industry; medial laboratories are faced with similar problems as well. When dealing with vast numbers of laboratory specimens, it is essential to accurately record, process and track laboratory specimens throughout the lab process. However, it has been observed that many data-entry related errors occur during specimen collection, processing, analysis and archiving. For example, during blood processing, blood samples undergo rigorous testing procedures including blood typing, screening for hepatitis, syphilis, HTLV-I, HIV, etc. Blood that tests positive is usually destroyed; otherwise, it is distributed to hospitals for trauma victims, premature newborns, and patients undergoing surgery, cancer treatment and other procedures. The blood processing procedures often require laboratory technicians to manually enter into various forms, computers and blood analyzing equipment 12- to 15-digit accession and block numbers of the processed specimens, as well as to record time and date of a particular test. These manual methods of data recording are prone to potential errors, whether from illegible handwriting, typos or other data-entry related errors. These data-entry methods often lead to incorrect identification of blood samples or other specimens that forces technicians to repeat various complex and time-consuming tests.

Thus, there is a need to improve performance and reliability of healthcare-related services, and, more specifically, there is a demand for a more efficient and effective data entry and transfer techniques in the diagnostic, treatment and laboratory processing segments of the healthcare industry. Furthermore, there is a more general need in the art of data measurement and processing to provide a solution to the problem of transferring information from a variety of measuring devices to a variety of data recognition and acquisition devices. There is also a need to provide new and different solutions for processing the acquired data in an efficient and error-free manner.

### SUMMARY OF THE INVENTION

In one embodiment, the invention provides a measuring apparatus comprising: a sensor operable to take a measurement reading; means for generating measurement data from the sensor reading; processing means for converting the measurement data into one or more barcode formats; means for maintaining the displayed measurement until subsequently changed by a later measurement; and an electronic display operable to display the measurement data in an alphanumeric format and at least one changeable barcode.

In another embodiment, the invention provides a system for processing measurement data, the system comprising a measuring apparatus comprising: a sensor operable to take a measurement reading; means for generating measurement data from the sensor reading; processing means for converting the measurement data into one or more barcode formats; means for maintaining the displayed measurement until subsequently changed by a later measurement; and an electronic display operable to display the measurement data in an alphanumeric format and at least one changeable barcode; a barcode scanner operable to scan the changeable barcode-formatted measurement data from the electronic display of the measuring apparatus; and a computer system comprising a memory and a processor, the computer system is operable to: (i) receive the measurement data from the barcode scanner; and (ii) store the measurement data in the memory.

In one embodiment, the invention provides a method for processing measurement data collected by a measuring apparatus comprising: a sensor operable to take a measurement reading; means for generating measurement data from the sensor reading; processing means for converting the measurement data into one or more barcode formats; means for maintaining the displayed measurement until subsequently changed by a later measurement; and an electronic display operable to display the measurement data in an alphanumeric format and at least one changeable barcode, the method comprising: determining one or more characteristics of the display device; determining one or more characteristics of the measurement data; selecting a changeable barcode format for displaying measurement data based on the characteristics of the display device and the characteristics of the measurement data; converting the measurement data into the selected changeable barcode format; and electronically displaying the converted measurement data in an alphanumeric format and the selected changeable barcode format, whereby the selected barcode display changes simultaneously with the measurement.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

Various embodiments of the present invention are illustrated in the following drawings, which are meant to be exemplary only and are not limiting on the scope of the present invention, and in which:

FIG. 1 is a block diagram of a system for processing measurement data according to one embodiment of the present invention;

FIG. 2 is a diagram depicting exemplary barcode symbologies;

FIG. 3 is a block diagram of a system for processing measurement data according to one embodiment of the present invention;

FIG. 4 is a block diagram of a system for processing measurement data according to one embodiment of the present invention;

FIG. 5 is a block diagram of a system for processing measurement data according to another embodiment of the present invention;

FIG. 6 is a flowchart of a method for selecting a barcode symbology for displaying medical measurement data according to one embodiment of the present invention;

FIG. 7 is a flowchart of a method for processing measurement data according to one embodiment of the present invention; and

FIG. 8 is a flowchart of a method for processing measurement data according to another embodiment of the present invention.

### DETAILED DESCRIPTION OF THE INVENTION

In the following description of the various embodiments of the present invention, reference is made to the accompanying drawings that form a part hereof, and in which is shown by way of illustration various embodiments of the present invention. It is to be understood that the scope of the present invention is not limited by the following description and by the accompanying drawings.

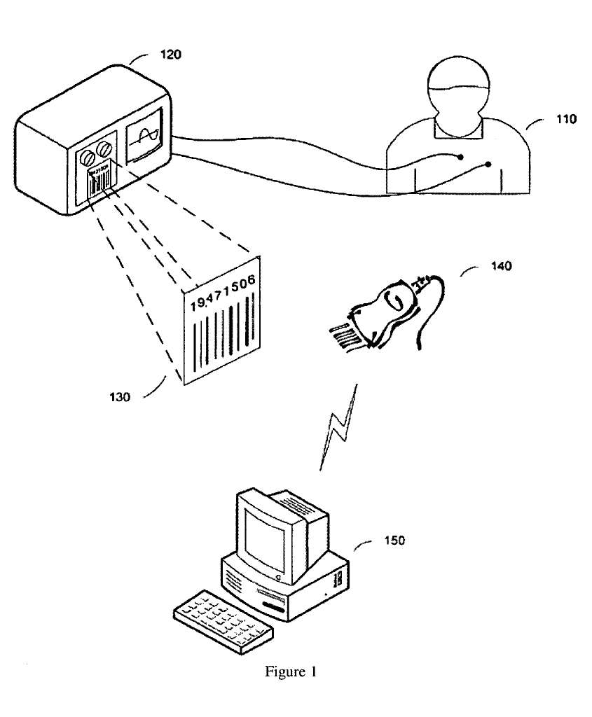

FIG. 1 illustrates a system for medical measurement data processing in accordance with one embodiment the present invention. As depicted, the system comprises a medical measuring apparatus 120 that may be used in various healthcare applications including diagnostics and treatment of patients as well as in medial laboratory processes. In one embodiment, the medical measuring apparatus 120 may be used in healthcare diagnostic environment to measure, for example, using one or more sensors 125 various vital signs of a patient 110. In another embodiment, the medical measuring apparatus 120 may be used in a laboratory environment to perform chemical composition analysis on various bodily fluid, tissue specimens, or the like. In accordance with various embodiments of the present invention, the medical measuring apparatus 120 may be used in many other areas of healthcare, as well as the non-medical fields, to perform measurements using various sensors 125, which may include, but are not limited to, optical, acoustic, piezoelectric, magnetic, electromagnetic, thermal, chemical sensors and the like.

In accordance with one embodiment of the present invention, the medical measuring apparatus 120 is operable to process the medical measurement readings generated by the sensors 125 and to display medical measurement data on a display device 130, which may comprise a cathode ray tube (“CRT”), liquid crystal display (“LCD”), or the like. In one embodiment, the medical measuring apparatus 120 may process and display the generated medical measurement data in a human-readable and machine-readable graphic formats or patterns. In one embodiment, the human-readable graphic format may include, for example, a string of alphanumeric characters. The machine-readable graphic format may include, but is not limited to, a barcode format or any other graphic pattern that may be read by a machine using various optical sensors. An exemplary embodiment of the display device 130 is shown in FIG. 1, in which the medical measurement data is displayed as an alphanumeric string of characters followed by a linear barcode having a series of spaced thick and thin vertical bars.

In one embodiment of the present invention, the system may further comprise a scanning device or other data recognition/acquisition device 140 operable to read machine-readable format measurement data off the display device 130. The scanning device may comprise, for example, a laser barcode scanner. In one embodiment, the laser scanner 140 may be operable to scan a laser beam across the barcode pattern formed on the display device 130 of the medical measuring apparatus 120 and to detect reflections from the pattern using a photosensitive element therein. Sensed reflections from the barcode elements are used to generate pulses having pulse lengths proportional to the thicknesses of the bars. Timing circuits within the scanning device 140 may measure the width of the pulses and spaces therebetween, which are, in effect, negative barcode elements. Logic circuitry within the scanner 140 associates the detected pulse patterns with the corresponding characters. The scanner 140 may scan a barcode pattern multiple times to increase accuracy. In one embodiment of the present invention, barcode scanners manufactured by Symbol Technologies, Inc. may be used for scanning medical measurement data of the display device 130 of the medical measuring apparatus 120.

In one embodiment of the invention, the scanning device 140 may transmit through a wired or wireless connection the medical measurement data to a computer system 150 for collection and storage. Alternatively, the scanning device 140 may temporarily store the collected measurement data in the internal memory before transmitting the data to the computer system 150. In one embodiment, the computer system 150 may comprises an interface for communicating with the scanning device 140, which may include, for example, a FireWire port, USB port, infrared connection, Ethernet, wireless LAN, Bluetooth, or the like. The computer system 150 may further comprise a central processing unit (“CPU”) and various forms and configurations of random access and non-volatile memory. The computer system 150 may be operable to collect the medical measurement data and to store it locally or send it via a local area network to a central database where all medical records may be stored.

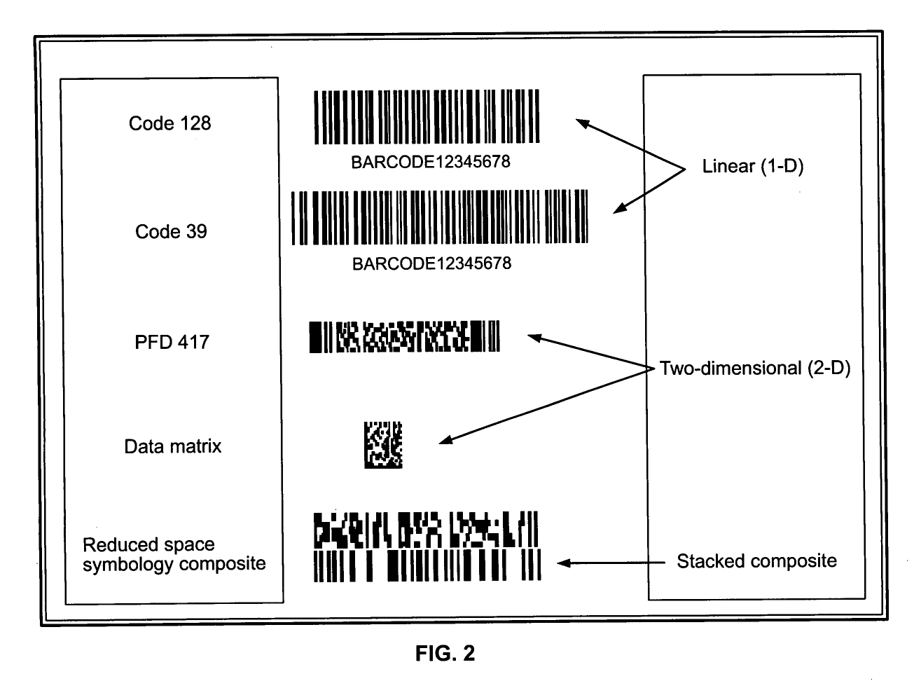

In accordance with one embodiment of the present invention, the medical measuring apparatus may utilize various barcode symbologies to display measurement data. FIG. 2 illustrates several types of barcode symbologies that may be used in various embodiments of the present invention; such barcode symbologies include, but are not limited to linear, two-dimensional and stacked barcode symbologies. Generally, all barcode patterns are made up of combinations of thick and thin “bars” or linear elements, such as thick and thin dark bars combined with thick and thin light bars or separations. Some barcodes have multiple bar thicknesses. Each alphanumeric symbol to be represented is associated with a unique barcode pattern. A conventional barcode includes information at one or both ends indicating which direction the barcode is oriented (in case it is scanned upside-down), and there may be size or scale information embedded in the barcode. There is also a data section that includes the information encoded in the barcode. Typically, barcodes can be of various sizes and may be scanned at different lengths from the scanner. There may be guidelines that determine various characteristics of the barcodes. It should be noted that the medical measuring apparatus of the present invention may generate both the conventional barcodes symbologies as well as the proprietary barcode formats.

More specifically, linear barcode symbologies fall into two general categories: discrete symbologies and continuous symbologies. In a discrete barcode, each character can stand alone and can be decoded independently from adjacent characters. Each character is separated from the adjacent characters by loosely toleranced intercharacter gaps, which contain no information. Every character has a bar at each end. An example of a discrete barcode that may be used to represent alphabetic, numeric, and control characters in accordance with one embodiment of the present invention is a Code 39 symbology, sample of which is shown in FIG. 2. In contrast, a continuous barcode has no intercharacter gaps. Every character starts with a bar and ends with a space. The end of one character is indicated by the start of the next. An example of a continuous barcode that may be used in accordance with one embodiment of the present invention to represent alphabetic, numeric, and control characters is a Code 128 symbology, sample of which is also shown in FIG. 2.

In one embodiment of the present invention, the measuring apparatus may also display measurement data using two-dimensional (2-D) barcode symbology. In this symbology, the data may be encoded in both the horizontal and vertical dimensions. 2-D barcodes generally features square or dot-shaped modules arranged on a grid pattern. FIG. 2 shows two common used 2-D symbologies: PDF417 and data matrix. The PDF417 barcode consists of several linear rows of stacked codewords. Each codeword represents one of about thousand possible values from one of three different clusters. A different cluster is chosen for each row, repeating after every three rows. The data matrix symbology uses a unique perimeter pattern, which helps the barcode scanner determine the cell locations. The cells are made up of square modules. Because it can encode letters, numbers, text and actual bytes of data, it can encode just about anything including text characters, unicode characters and photos. The data matrix may be used to encode few digits to several hundred digits of data.

In one embodiment of the present invention, the measuring apparatus may also display measurement data using stacked composite barcode symbology. Stacked barcode is a combination of a linear barcode component or reduced space symbology (RSS) component and a special 2-D composite component (CC) printed on top thereof. In accordance with one embodiment, the linear component or RSS component may be used to encode primary measurement data. The adjacent 2-D composite component may be used to encode supplemental data, such as the type of the measurement, the time and date of the measurement, the name of the patient, or the like. FIG. 2 illustrates an example of a stacked composite symbology, known as reduced space symbology (RSS) composite component, which may be used to display measurement data in accordance with one embodiment of the present invention.

It should be noted that in various embodiments of the present invention different types of optical devices may be used to read barcode patterns displayed by the medical measuring apparatus. For example, in one embodiment of the present invention, linear barcode symbology may be read by a laser scanner, which would sweep a beam of light across the barcode in a straight line, reading a slice of the barcode light-dark patterns. Likewise, in accordance with one embodiment, a laser scanner may be used to read some stacked barcode symbologies, with the laser making multiple passes across the barcode. In contrast, a camera capture device, such as an analog or digital camera, may be used in one embodiment of the present invention to capture and process two-dimensional barcode pattern and some stacked barcode symbologies.

It should also be noted that the medical measuring apparatus of the present invention may be operable to analyze medical measurement data and to select barcode symbology for displaying the measurement data in accordance with one embodiment of the present invention. In particular, the measurement device may chose between several barcode symbologies stored in its memory and may select an optimum symbology based on its characteristics, such as its capacity to hold data. For example, linear barcodes get longer as more data is encoded, while the 2-D barcodes provide much better data capacity for a given barcode length, and the composite barcodes provide even better data capacity to barcode size ratio. Furthermore, the barcodes of the same type may have different capacities. For example, for the same number of characters, the Code 128 barcode may be twice shorter than the Code 39 barcode, which are both linear barcodes. Thus, depending on the size and resolution of the display device as well as the number of characters/numbers in the medical data, the medical measuring apparatus may select an optimum barcode symbology for displaying the medical measurement data in accordance with one embodiment of the present invention.

In another embodiment, the medical measuring apparatus of the present invention may be configured to display medical measurement data in a default barcode format. For example, some medical measuring apparatus may be operable to perform only one or few types of medical measurement and generate medical data having a fixed number of digits. Such apparatus may include, but are not limited to, digital thermometers, blood pressure and blood sugar analyzers, or the like. Thus, a digital thermometer, for example, may be configured in accordance with one embodiment of the present invention to display the measured temperature data, which may have only five significant digits: three whole digits and two decimal digits, using a default linear symbology, such as a Code 39 symbology. Alternatively, the thermometer may be configured to display measured temperature data using a default Code 128 symbology, or the like.

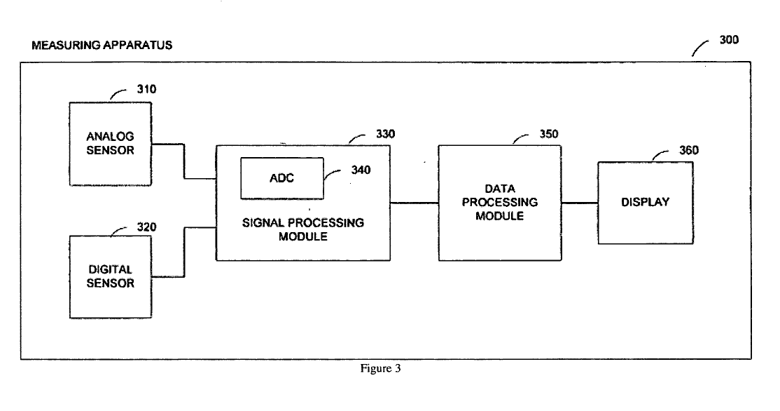

FIG. 3 illustrates a block diagram of the medical measuring apparatus in accordance with one embodiment of the present invention. As depicted, the medical measuring apparatus 300 may comprise a plurality of analog sensors 310 and/or digital sensors 320 for performing one or more readings. The apparatus 300 further comprises a signal-processing module 330 that may be operable to receive digital measurement readings from sensors 310 and 320 and to convert these sensor readings into measurement data in a digital format. The signal-processing module 330 may comprise an analog-to-digital converter 340, which may be operable to convert analog sensor readings into digital format. The apparatus 300 may further comprise a data processing module 350 that may be operable to analyze medical measurement data and to convert the medical measurement data into the alphanumeric format and one or more barcode formats. The apparatus 300 may also include a display device 360 for displaying medical measurement data in the alphanumeric and barcode formats. Individual elements of the medical apparatus 300 will be described in more detail next.

In accordance with one embodiment of the present invention, the medical measuring apparatus 300 may comprise one or more analog sensors 310 and/or digital sensors 320 for performing medical readings. An analog sensor 310 may be a sensing device that converts an analog physical quantity, such as temperature or strain, to a proportional analog electrical signal, such as current, charge, or voltages In contrast, a digital sensor 320 may output discrete rather than continuous signals. In various embodiments, the sensors 310 and 320 may comprise one or more of optical, acoustic, piezoelectric, magnetic, electromagnetic, thermal and chemical sensors. In one embodiment, the sensors 310 and 320 may be integrated within the measuring apparatus 300. In another embodiment, the sensors 310 and 320 may be remotely connected to the measuring apparatus 300 using wired or wireless connection.

In accordance with one embodiment of the present invention, the medical measuring apparatus 300 may further comprise a signal processing module 330 that may be operable to receive analog signals from analog sensors 310 and digital signals from digital sensors 320, to process the received sensor reading, and to generate digital measurement data. In one embodiment, the signal-processing module 330 may comprise a clock circuit or a counting circuit that will convert digital input data from the digital sensor 320 into medical measurement data having a predefined number of bits, e.g., eight bits. In one embodiment, the signal-processing module 330 may further comprise an analog-to-digital converter (ADC) 340 for converting analog input signals received from the analog sensors 310 into the digital format. The ADC 340 may be operable to sample the analog input signal at a continuous rate to generate digital data having a predefined number of bits. For example, the ADC 340 may encode the analog input signal to one of 256 discrete values so as to generate digital data having eight bits per sample. In one embodiment of the present invention, the ADC 340 may comprise one of integrated circuit (“IC”) analog-to-digital converters manufactured by National Semiconductor Corporation. One of skill in the art will recognize that various other types of analog-to-digital converters may be used in different embodiments of the present invention. In various embodiments, the signal-processing module 330 may also amplify the input analog signals and apply various digital and analog filters to improve signal-to-noise ratio of the sensor signals. The signal-processing module 330 may also analyze the analog input signals in the time, space and frequency domains using various signal processing techniques known to those of ordinary skill in the art of data processing.

In accordance with one embodiment of the present invention, the medical measuring apparatus 300 may further comprise a data processing module 350 that may be operable to receive medical measurement data from the signal-processing module 330 and to generate activation signals for displaying on the display device 360 medical measurement data in the human-readable and machine-readable formats. For example, the data processing module 350 may generate activation signals for displaying measurement data in an alphanumeric and one or more barcode formats. In another embodiment, the data processing module 350 may be operable to analyze medical measurement data received from the signal-processing module 330 as well as the characteristics of the display device 360 and to select an optimum barcode symbology for displaying the medical measurement data.

In one embodiment of the present invention, the data processing module may be implemented as one or more dedicated circuits integrated on a single chip for performing various functionalities, such as data analysis, alphanumeric encoding, and/or barcode encoding. In another embodiment, the data processing module may be implemented using a general-purpose processor, such as those manufactured by Motorola and Intel Corporation, being programmed with instructions for analyzing medical measurement data and performing alphanumeric and barcode encodings. One or more instruction sets for programming a general-purpose processor to analyze medical measurement data and to perform alphanumeric and barcode encodings in accordance with various embodiments described therein may be provided on a computer readable medium, such a compact disk, in one embodiment of the present invention.

n accordance with one embodiment of the present invention, the medical measuring apparatus 300 may also comprise a display device 360. The display device 360 may be implemented using, for example, a cathode ray tube (“CRT”), liquid crystal display (“LCD”) technology, or the like. The barcode display elements may be activated in patterns to form a barcode pattern, which may be scanned by a conventional scanning device, such as a laser barcode scanner, a digital camera, or the like. The distance between the adjacent barcode elements should be sufficient for the scanning device to resolve individual barcode elements. If the spacing between adjacent barcode display elements is less than that which can be detected by the scanning device, multiple adjacent barcode display elements may be activated to form relatively wide bars of the barcode symbology. The display device 360 may also include alphanumeric display elements, which may be simultaneously activated to form human-readable symbols corresponding to characters represented by the barcode pattern. A dynamic LCD display that may be used in connection with the measuring apparatus in accordance with one embodiment of the present invention is disclosed in the U.S. Pat. No. 6,082,620 entitled “Liquid Crystal Dynamic Barcode Display”, which is incorporated by reference herein in its entirety.

In accordance with one embodiment of the present invention, the medical measuring apparatus 300 may also comprise an interface (not shown) for enabling a user of the measuring apparatus to configure various display setting or the like. For example, the interface may enable the user to select a particular barcode symbology for displaying the medical measurement data. This may be necessitated by the particularity of the medical measurement or other supplemental data that the user wishes to be displayed in a given barcode format next to the measurement data. Also, if the scanning device is operable to scan only a particular barcode symbology, e.g., a linear symbology, the user may wish to set the measuring apparatus 300 to display the measurement data in the barcode format recognizable to scanning device. One of skill in the art may recognize that the interface may be used to set or adjust many other parameters of the medical measuring apparatus 300.

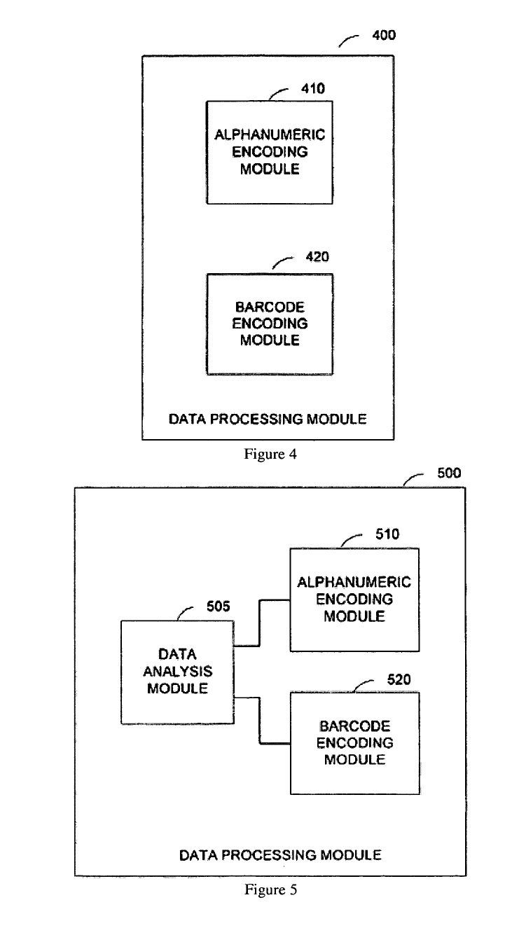

FIG. 4 illustrates one embodiment of the data processing module of the present invention. As depicted, a data processing module 400 may comprise an alphanumeric encoding module 410 and a barcode encoding module 420. The barcode encoding-module 420 may be operable to receive medical measurement data in a digital format from the signal-processing module and to convert this data into activation signals to form the barcode pattern on the display device of the medical measuring apparatus. In one embodiment, the barcode-encoding module 420 may be configured to generate barcode data for a default barcode symbology, such as Code 39, Code 128, PDF417, etc. The barcode encoder module 420 may be implemented as a dedicated circuit or as a general-purpose processor programmed with an instruction set for performing the given barcode encoding. Various shareware and commercial programs for performing barcode encoding of digital data are available for download or purchase on the Internet from different distributors; such barcode encoding programs may be readily used by those of ordinary skill in the art.

As depicted in FIG. 4, the data processing module 400 may also comprise an alphanumeric encoding module 410. The alphanumeric encoding module 410 is operable to receive the medical measurement data in a digital format from the signal-processing module and to convert the received data into activation signals to form various alphanumeric characters on the display device of the medical measuring apparatus. In one embodiment, the alphanumeric encoding module 410 may comprise a conventional seven-segment encoder for generating seven-segment characters. In another embodiment, the alphanumeric encoding module 410 may comprise a dot-matrix encoder for generating a full set of alphanumeric characters. Furthermore, it should be noted that both the alphanumeric encoding module 410 and barcode encoding module 420 may include a latching circuitry or an instruction set for maintaining the displayed patterns until subsequently changed by a later reading.

FIG. 5 illustrates another embodiment of the data processing module of the present invention. As depicted, the data processing module 500 may comprise a data analysis module 505 that may be operable to analyze medical measurement data received from the signal-processing module as well as the characteristics of the display device of the medical measuring apparatus and to select a barcode symbology for displaying the measurement data. In this embodiment, the data processing module 500 may also comprise an alphanumeric encoding module 510 operable to convert medical measurement data into activation signals to form various alphanumeric characters on the display device of the medical measuring apparatus. The data processing module 500 may also comprise a barcode encoding-module 520 operable to covert medical measurement data into activation signals to form the barcode pattern on the display device of the medical measuring apparatus.

More specifically, the data analysis module 505 may comprise a general-purpose processor or a dedicated circuit configured to select an optimum barcode symbology for displaying medical measurement data. In one embodiment, the data analysis module 505 may maintain a library of one or more barcode encoding algorithms, such as Code 39, Code 128, PDF417, Data Matrix, RSS, or the like. The data analysis module 505 may apply a different barcode encoding algorithm to a given data measurement depending on the various characteristics of the measurement data as well as of the characteristics of the display device of the measuring apparatus. The characteristics of the measurement data may include, but are not limited to, the total number of digits and/or numbers in the data to be displayed in the barcode format by the measuring apparatus. The characteristics of the display device of the measuring apparatus may include, but are not limited to, the size of the display device, e.g., in inches, the resolution of the display device, such as number of pixels or segments per a given display area, the dot (pixel) pitch of the display device, such as the distance between individual pixels, or the like. The data analysis module 505 may also use other characteristics of the measurement data, the measuring apparatus, as well as of the scanning device in selecting an optimum barcode symbology for displaying the measurement data.

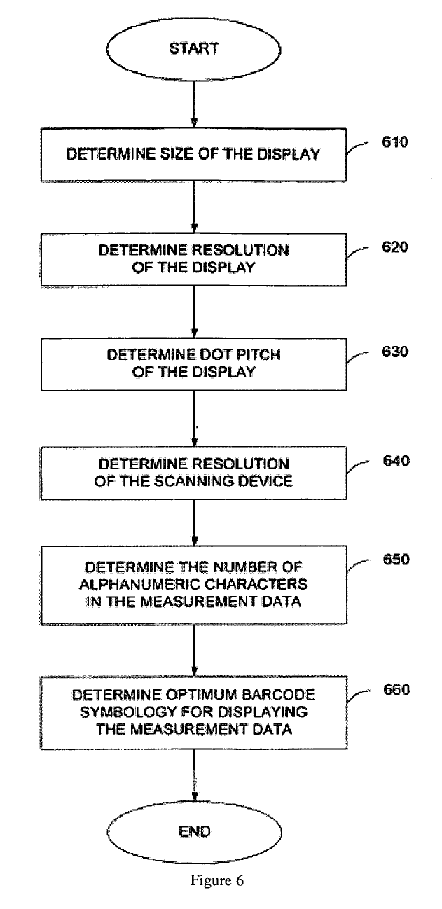

FIG. 6 illustrates an exemplary algorithm that may be used by the data analysis module for optimizing barcode symbology in accordance with one embodiment of the present invention. At step 610, the data processing module may determine the size of the display device of the measuring apparatus. The size of the display device may determine, for example, the number of barcode characters that may be displayed on the measuring apparatus. Thus, a larger display device may display more barcode characters and thus more measurement data than a smaller display device. At step 620, the data processing module may determine the resolution of the display device of the measuring apparatus. In the dot-matrix displays, the resolution parameter provides a number of pixels across the width and length of the display. Thus, the larger is the resolution the more barcode elements may be displayed on the display device. At step 630, the data processing module may determine the dot (pixel) pitch of the display device. This parameter provides information about the distance, e.g. in millimeters, between adjacent pixels. The dot pitch parameter may be used to determine how many pixels may be used to display each barcode element. If the dot pitch number is small and the resolution of the display device is high more pixels may need to be used to generate each barcode element so that the optical circuitry of the scanning device may resolve each barcode element. At step 640, the data processing module may determine the resolution of the scanning device. This parameter determines how closely may the barcode elements be placed on the display device of the measuring apparatus to be detected by the scanning device. At step 650, the data processing module may determine the number of characters in the measurement data. For example, if there are too many digits in the measurement data to be displayed in the barcode format, the data processing module may round off or truncate one or more insignificant digits, so that the barcode pattern representing the measurement data can fit on the display of the measuring apparatus. Likewise, if the patient data, such as his last and first name, is too long to fit the available display space, the data processing module may, for example, display only the last name of the patient. Lastly, at step 660, the data processing module may search through its barcode library and select an optimum barcode symbology based on such factors as barcode data capacity, barcode size and resolution, the size, resolution and dot pitch of the display device, as well as the resolution of the scanning device. One of skill in the art may recognize that not all of the aforementioned parameters as well as many other parameters may be used to select an optimum barcode symbology for displaying the measurement data in accordance with various embodiments of the present invention.

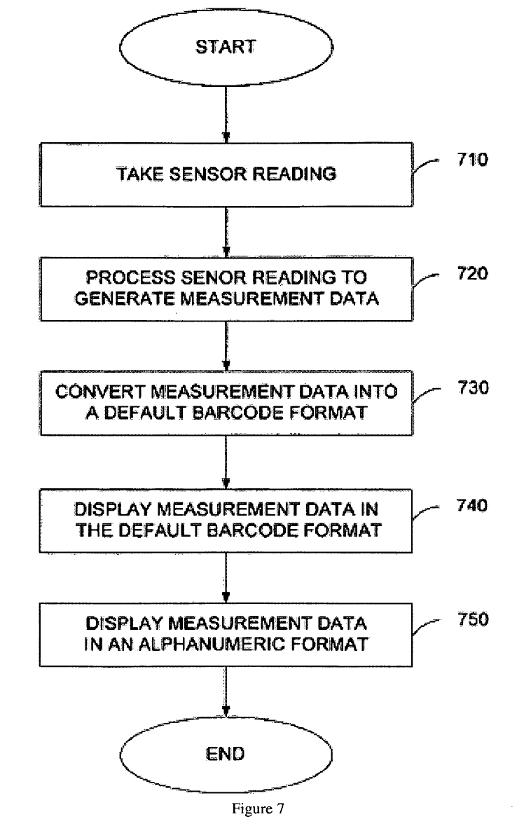

FIG. 7 is a flowchart depicting a method for processing measurement data in accordance with one embodiment of the present invention. At step 710, the medical measuring apparatus may take one or more measurement readings using various digital and/or analog sensors. The readings may include various vital sign readings, such as temperature, blood pressure, or the like; the readings may be also indicative of chemical composition of a bodily fluid, tissue specimen, or the like. At step 720, the medical measuring apparatus may process the analog and digital sensor readings to generate medical measurement data, which may include, but is not limited to, various measure parameters received from the digital and/or analog sensors as well as various other parameters including name of the patient, the date and time of the sensor reading, and the like. At step 730, the medical measurement data may be converted into a default barcode format, which may include, but is not limited to, Code 39, Code 128, PDF417, Data Matrix, RSS, or the like. At step 740, the medical measurement data may be displayed in the default barcode format on the display device of the measuring apparatus. At step 750, the measuring apparatus may display measurement data in a human readable format, such as a string of alphanumeric characters. The above process may then be repeated to collect, process and display another medical measurement reading.

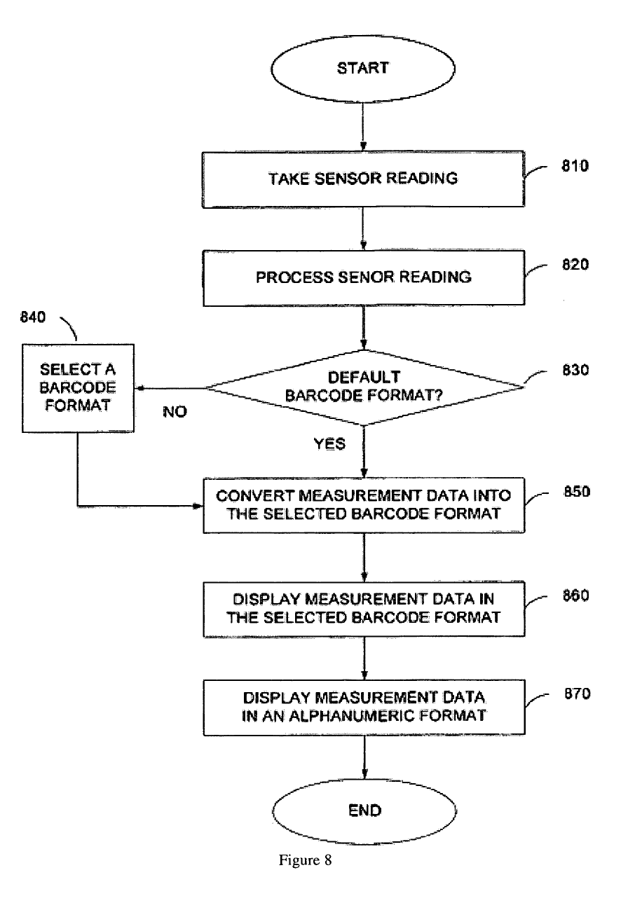

FIG. 8 is a flowchart depicting a method for processing measurement data in accordance with another embodiment of the present invention. At step 810, the medical measuring apparatus may take one or more measurement readings using various digital and/or analog sensors. At step 820, the medical measuring apparatus may process the analog and digital sensor readings to generate medical measurement data. At step 830, the medical measuring apparatus may determine whether the user have specified a default barcode format for displaying the measurement data. If no default barcode format was specified, the medical measuring apparatus may at step 840 select an optimum barcode symbology for displaying the measurement data. For example, the medical measuring apparatus may search through its barcode library and select an optimum barcode symbology based on such factors as barcode data capacity, barcode size and resolution, the size, resolution and dot pitch of the display device, resolution of the scanning device, or the like. At step 850, the medical measuring apparatus may convert the medical measurement data into the selected barcode format. At step 860, the medical measuring apparatus may display the medical measurement data in the selected barcode format. Finally, at step 870, the measuring apparatus may display measurement data in a human-readable format, such as a string of alphanumeric characters. The above process may then be repeated to collect, process and display another medical measurement reading.

Even thought the system and methods for measurement data processing have been described with reference to the medical and healthcare-related fields, the present invention is not limited to these fields and may be used in any other type of measurement system, which requires efficient and effective data entry and transfer techniques as well as processing of the acquired digital and analog data in an efficient and error-free manner.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A measuring apparatus comprising: a sensor operable to take a measurement reading; means for generating measurement data from the sensor reading; processing means for converting the measurement data into one or more barcode formats; means for maintaining the displayed measurement until subsequently changed by a later measurement; and an electronic display operable to display the measurement data in an alphanumeric format and at least one changeable barcode.

2. The apparatus of claim 1, wherein the processing means of the measuring apparatus are operable to select a barcode format for displaying the measurement data.

3. The apparatus of claim 2, wherein the barcode format is a linear barcode formats, two-dimensional barcode formats, or a composite barcode formats.

4. The apparatus of claim 1, wherein the measuring apparatus further comprises an interface for receiving user input indicating the format in which to display the measurement data.

5. The apparatus of claim 1, wherein a sensor comprises an optical, acoustic, piezoelectric, magnetic, electromagnetic, thermal, chemical sensors or their combination.

6. The apparatus of claim 1, wherein the measurement data is indicative of a vital sign of a living organism.

7. The apparatus of claim 1, wherein the measurement data is indicative of a chemical composition of a bodily fluid or a tissue specimen.

8. The apparatus of claim 1, whereby the means for maintaining the displayed measurement until subsequently changed is a latching circuitry or an instruction set.

9. A system for processing measurement data, the system comprising the apparatus of claim 1; a barcode scanner operable to scan the changeable barcode-formatted measurement data from the electronic display of the measuring apparatus; and a computer system comprising a memory and a processor, the computer system is operable to: (i) receive the measurement data from the barcode scanner; and (ii) store the measurement data in the memory.

10. The system of claim 9, further operable to display the time of at least one received sensor reading in the alphanumeric format and at least one changeable barcode format.

11. A method for processing measurement data collected by the measuring apparatus of claim 1, the method comprising: determining one or more characteristics of the display device; determining one or more characteristics of the measurement data; selecting a changeable barcode format for displaying measurement data based on the characteristics of the display device and the characteristics of the measurement data; converting the measurement data into the selected changeable barcode format; and electronically displaying the converted measurement data in an alphanumeric format and the selected changeable barcode format, whereby the selected barcode display changes simultaneously with the measurement.

12. The method of claim 11, whereby a characteristic of the display device comprises one or more of size, resolution, and dot pitch of the display device.

13. The method of claim 11, whereby a characteristic of the measurement data comprises one or more of the number of characters and significant digits in the measurement data.

14. The method of claim 11, whereby a characteristic of the measurement data comprises a displayed barcode that is capable of changing simultaneously with the measurement.

15. The method of claim 11, further comprising the steps of scanning the barcode with a barcode scanner operable to scan the changeable barcode-formatted measurement data from the electronic display of the measuring apparatus.

16. The method of claim 15, further comprising the step of receiving the measurement data from the barcode scanner; and storing the measurement data in a computer readable format.
